(19) United States
(12) Patent Application Publication
(10) Pub. No.: US 2010/0229081 A1
(43) Pub. Date: Sep. 9, 2010

(54) Method for Providing a Navigation Element in an Application

(75) Inventor: Sebastian Rothbucher, Frankfurt am Main (DE)

Correspondence Address: HOFFMAN WARNICK LLC, 75 STATE ST, 14 FL, ALBANY, NY, 12207, US

(73) Assignee: INTERNATIONAL BUSINESS MACHINES CORPORATION, Armonk, NY (US)

(21) Appl. No.: 12/676,739

(22) PCT Filed: Aug. 5, 2008
(86) PCT No.: PCT/EP08/60256

§ 371 Date: Mar. 16, 2010

(30) Foreign Application Priority Data
Sep. 6, 2007 (EP) 07115786.1

(51) Int. Cl. G06F 17/00

(52) U.S. Cl. 715/205

(57) ABSTRACT

Integration of a first application and at least one second application can be done in the following way without requiring changes to the application source code even if the number or identity of the second application(s) changes. The first application reads a first piece of information identifying a reference provider and a second piece of information associated with information to be fetched from a second application from a configuration entry. The first application retrieves a reference from said reference provider, said reference referring to said information to be fetched from said second application and conforming to a format expected by said second application. The first application presents a navigation element associated with said reference to a user.

### BACKGROUND

1. Field of the Invention

The invention relates to a method for providing a navigation element in an application.

2. Related Art

Many of today's enterprise applications are not integrated among each other in terms of their user interface. This especially holds true for out-of-the-box applications. By an out-of-the-box application is meant an application that does not require any additional installations, plug-ins, expansion packs, or products.

The World Wide Web, commonly referred to as Web, is a system for accessing interlinked hypertext documents and applications via the Internet. A perceived second generation of Web-based communities and hosted services which facilitate collaboration and sharing between users is commonly referred to as Web 2.0. A Web 2.0 website may feature the technique of using a Web application hybrid, commonly called mashup, to combine content from more than one source into an integrated experience, typically by presenting them as a single web page. The Internet article “http://www.dapper.net/faqs.php” describes a service that allows web developers to extract and use information from any website on the Internet, thus creating a mashup.

Examples of sources of content are portlets, that is, pluggable user interface components that are managed and displayed in a website called a web portal. One example of a product for building web portals is IBM WebSphere Portal Server.

While a web portal allows one web page displayed in a web browser to display several applications in an integrated view, changes in the data to be passed to a portlet require changes to the portal itself.

The publication “Data Integration Support for Mashups”, Sixth International Workshop on Information Integration on the Web, by A. Thor et al., IIWeb, July 2007, Leipzig, discloses a framework for the development of dynamic data integration mashups. A script-based definition of mashups facilitates the development as well as the dynamic execution of mashups. A functionality of the mashup script is provided as a web service and can be invoked by a web interface or by another web service.

The publication “Mashup Feeds: Continuous Queries over Web Services” by J. Tatemura et al., Conference Proceedings—SIGMOD '07, 12-14 Jun. 2007, Beijing, discloses mashup feeds as a system that supports integrated web service feeds as continous queries. The system comprises interfaces for the end users to subscribe to the developed mashup feeds.

The invention that is presented here aims to address the integration of Web applications in a flexible manner.

### SUMMARY OF THE INVENTION

A first aspect of the invention provides a computerized method for providing a navigation element in a first application, comprising the steps of

reading from a configuration entry a first piece of information identifying a reference provider and a second piece of information associated with information to be fetched from a second application,

retrieving a reference from the reference provider, the reference referring to the information to be fetched from the second application and conforming to a format expected by the second application, and

presenting a navigation element associated with the reference by the first application.

A method according to the invention may comprise the steps of

reading a parameter contained in the configuration entry,

replacing said parameter by a value defined in the first application, and

transmitting the value to the reference provider in retrieving the reference. The value may be based on a current state of the first application.

A method according to the invention may comprise receiving from the reference provider or the second application instructions for presenting the information to be fetched from the second application. Furthermore, the method may comprise the steps of

retrieving, in response to a user request, the information from the second application, and

presenting the information by the first application in accordance with the instructions.

A method according to the invention may comprise receiving information defining the navigation element from the reference provider.

As another option, the reference provider may be the second application. The reference provider may be the same entity as the first application.

The first and second applications may be Web applications, the navigation element may be a hyperlink targeting a uniform resource locator, and the information to be fetched from the second application may be a resource accessible via the World Wide Web.

A second aspect of the invention provides a computer program product comprising a computer useable medium having a computer readable program, wherein the computer readable program when executed on a computer causes the computer to:

read a first piece of information from a configuration entry by a first application, the first piece of information identifying a reference provider,

retrieve a reference from the reference provider by the first application, the reference referring to information to be fetched from a second application and conforming to a format expected by the second application,

present a navigation element associated with the reference by the first application.

A third aspect of the invention provides a data processing system for integrating applications, comprising

storage for storing a configuration entry containing a first piece of information for identifying a reference provider,

a communication module for communicating with further data processing systems,

a user interface device for presenting information, and

a processing component operatively connected to the storage, communication module and user interface device for retrieving a reference from the reference provider and presenting a navigation element associated with the reference using the user input device.

### BRIEF DESCRIPTION OF THE DRAWINGS

For a better understanding of the present invention and as how the same may be carried into effect, reference will now be made by way of example only to the accompanying drawings in which:

FIG. 1 shows a flowchart of a method according to an embodiment of the invention.

FIG. 2a shows an example of a configuration file for use with an embodiment of the invention. FIG. 2b shows the result of replacing parameters contained in the file of FIG. 2a.

FIG. 3 shows a block diagram of a typical configuration of the software of an embodiment of the present invention.

FIG. 4 shows an example of an XML document retrieved from a reference provider.

FIG. 5 shows an XML schema for the document according to FIG. 4.

FIG. 6 shows a system block diagram of a typical computer system used to execute the software of an embodiment of the present invention.

### DETAILED DESCRIPTION OF THE EMBODIMENTS OF THE INVENTION

The invention is applicable to applications in any computer-based network environment. In the following description, a Web application is used as an example of an application.

Integration of a first application and at least one second application can be done in the following way without requiring changes to the application source code even if the number or identity of the second application(s) changes. The first application reads a first piece of information identifying a reference provider and a second piece of information associated with information to be fetched from a second application from a configuration entry. The first application retrieves a reference from said reference provider, said reference referring to said information to be fetched from said second application and conforming to a format expected by said second application. The first application presents a navigation element associated with said reference to a user.

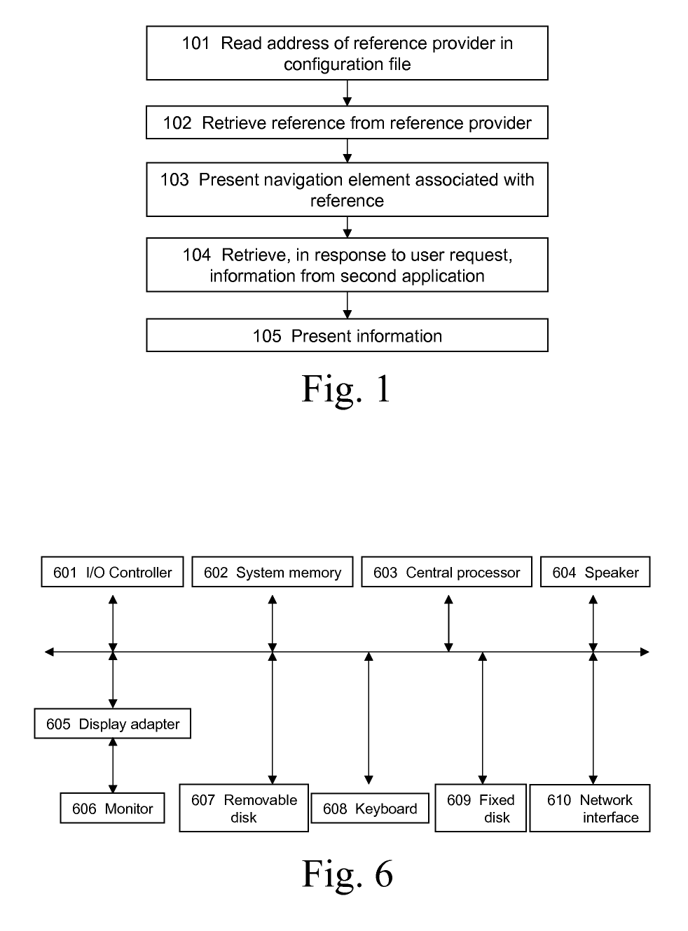

The invention is elucidated by reference to an embodiment in conjunction with FIG. 1. The method steps of FIG. 1 would typically be carried out by a first application, for example, a Web application.

In step 101, the first application reads from a configuration entry a first piece of information identifying a reference provider and a second piece of information associated with information to be fetched from a second application. The configuration entry is typically stored in a configuration file. The first piece of information is hereinafter referred to as the address of the reference provider. This reference provider would typically be a further Web application, its address then taking the form of a uniform resource locator (URL). By a URL is meant a global identifier of a document or resource retrievable via the World Wide Web. An example of a URL is “http://some.server/file.ext?param1=value1”. In this example, the URL encoded parameter “param1=value1” may serve the first application to customize content for a user who has visited the website containing that first application before. A typical configuration file may comprise a plurality of such URLs separated by line breaks.

A configuration file may also contain parameters or placeholders, each of which the first application would then replace by a value defined in that application, preferably upon or after reading the configuration file. The substituted values would typically be based on a state of that first application, for example, the value being the value of a variable stored by the application or the value of a data field currently displayed by the application. The substituted values would form part of the address of the reference provider, all further steps thus depending on these values. The support for parameter substitution thus yields the benefit of enabling a context-sensitive integration, that is, an integration that depends on the application context or the circumstances of a user interaction. See below for a detailed example of parameter substitution.

In step 102, the first application retrieves a reference from the reference provider, the reference referring to the information to be fetched from the second application and conforming to a format expected by the second application. As described above, the address of the reference provider read in step 101 would typically be a URL. This URL then defines the reference to be retrieved from the reference provider in step 102. An example of such a URL would be “http://localhost/cgi-bin/action_provider.pl?name=John+User&mode=detailed”. This URL implies that a representation of the reference is obtainable via Hypertext Transport Protocol (HTTP) from the local network host. HTTP is a communications protocol used to transfer or convey information on the World Wide Web. In this example, the first application would typically retrieve the reference from the reference provider by means of a HTTP request message. Using the Java 2 Platform Standard Edition programming language, such a request could be made by means of the class “java.net.HttpURLConnection”. Other programming languages may provide similar libraries. Alternatively, the HTTP communications protocol can be custom implemented.

If, as in this example, the URL specifies the “http:” scheme, the reference provider would typically take the form of a Web server. By a Web server is meant a computer program that is responsible for accepting HTTP requests from clients and serving them HTTP responses along with optional data contents. The reference provider may make use of the Common Gateway Interface (CGI) standard protocol for interfacing external application software with the Web server, allowing the server to pass requests from the first application to that external application. The Web server may then return the output from the external application to the first application. This output would typically be based on parameters of the configuration file read in step 101 and sent by the first application to the Web server.

The second application would typically be an even further Web application, the reference then comprising a further URL and referring to a resource of that Web application. The first and second application may also be identical, in which case the URL would identify a resource of that same application. Similarly, the second application and reference provider may be the same application.

In a preferred embodiment, the reference retrieved in step 102 would include information for generating a hyperlink, commonly referred to as a link. By a hyperlink is meant a navigation element that automatically brings the referred resource to the user when the navigation element is selected by the user. The further URL would then be the destination anchor of that hyperlink, commonly called the link target.

In addition to the reference of step 102, the first application may receive from the reference provider or from the second application instructions for presenting the information. For example, such instructions may indicate whether the information is to be displayed in a primary window or in a separate window of the first application.

In step 103, the first application presents a navigation element associated with the reference. The first application would typically generate that navigation element based on information included in the reference retrieved in step 102. Typically, the navigation element would be a hyperlink to be displayed by a Web browser in some distinguishing way, for example, in a different color, font, or style. For example, the Web browser may display a plurality of hyperlinks in the form of an action bar providing a means of choosing various actions from different sources, those actions being completely integrated into the user interface. Such actions may be displayed as buttons, allowing a user to click on a button to trigger the corresponding action. The action bar may also embed structured text, typically specified by means of Hypertext Markup Language (HTML), that is unrelated to any action.

In two optional steps 104 and 105, the first application may, in response to a user request, retrieve and present the referenced information. That user request would typically be expressed by selecting the navigation element presented in step 103. If the navigation element is a hyperlink, a user may select the navigation element by activating the hyperlink, for example, by clicking on it in a graphical Web browser. This will typically cause the Web browser to display the link target, that is, the resource of the second application identified by the URL contained in the reference retrieved in step 102. If the link target is not an HTML file, the Web browser may activate another computer program to open the file and present the referenced information. The selection of that program depends on the file type and on the Web browser and its plug-ins, that is, the computer programs that interact with the web browser to read specific types of files.

It is appreciated that, although examples of URLs have been discussed that specify the “http:” scheme, an embodiment of the invention may allow the use of URLs specifying different schemes. A first application according to such an embodiment would then typically need to support the protocol associated with that scheme to retrieve the link target.

The major benefit of embodiments of the invention is the integration of Web applications without necessitating modification of these integrating applications. In particular, no reprogramming or integration of additional code into an application or use of application programming interfaces (APIs) based on scripting languages is required by embodiments of the invention. By a scripting language is meant a computer programming language such as JavaScript that is typically interpreted and can be typed directly from a keyboard.

An additional benefit is the ability of the web developer to integrate applications residing on different computer systems, based on different programming languages or hardware platforms, enabling the use of open standards. A further advantage associated with the simplicity of the resulting integration pattern is the ability to create business applications that integrate easily with other business applications. This integration can be performed on the fly, that is, dynamically rather than as the result of a statically predefined integration architecture, thus simplifying continuous application development.

As an even further advantage, the second application may change the format of the request it expects to receive from the first application without necessitating a change in the first application. In this case, only the reference provider needs to be updated accordingly. This is especially advantageous if the second application also serves as the reference provider.

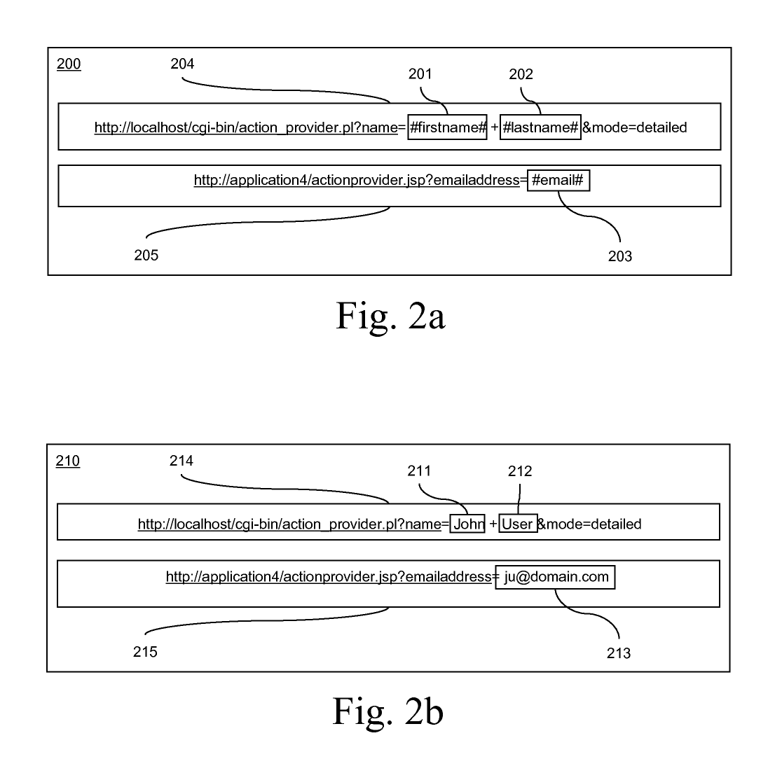

FIG. 2a shows an example of a configuration file for use with an embodiment of the invention. The configuration file 200 is a text file, each line 204 and 205 of which contains one complete URL. Line 204 includes parameters 201 and 202 for substitution by the first application. The URL scheme and underlying transport protocol are supported by the first application, that is, the first application is capable of processing the URLs 204 and 205 defined in the configuration file 200.

A typical method carried out by the first application for reading and processing the configuration file 200 might include opening the configuration file 200 for reading, scanning each line 204, 205 for parameters, and replacing each parameter 201, 202, 203 with a value defined in the first application. The first application would typically replace the parameters by means of string substitution.

It is appreciated that although embodiments of the invention have been discussed on the assumption that a file is used to store configuration parameters, this is not to be considered a restriction. It is possible to apply the same method based on configuration parameters stored in internal memory or any other memory means.

FIG. 2b shows the result of replacing parameters 201, 202, 203 contained in the configuration file 210. Here, the first application has replaced parameter 201 by value 211, parameter 202 by value 212, and parameter 203 by value 213. Values 211, 212 and 213 might typically be field values of a data record currently displayed by the first application. In the present example, these values represent a first name, last name, and e-mail address, respectively, of a user whose record is currently on display.

A person skilled in the art will appreciate that while, in the present example, hash marks (“#”) are used as delimiters for parameters, other delimiters or syntactic alternatives for identifying parameters are possible without departing from the principles of the invention.

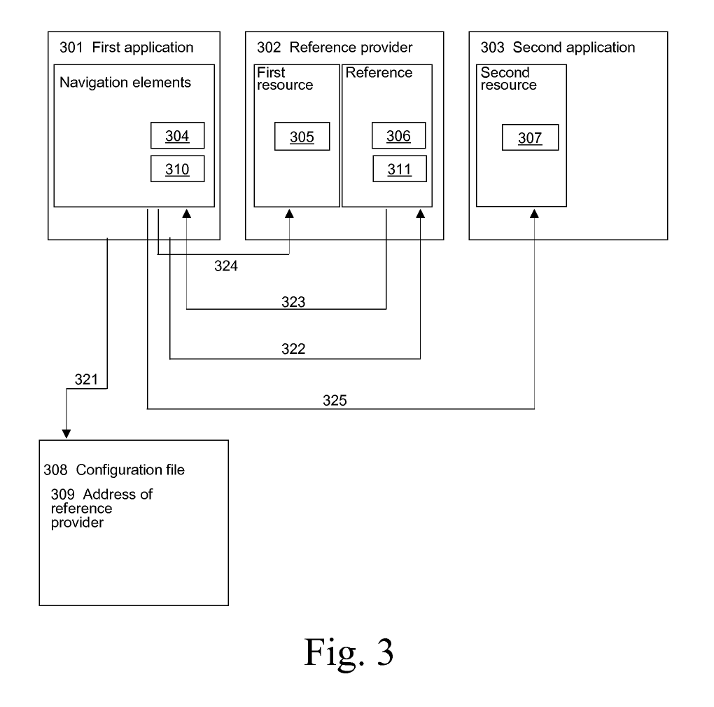

FIG. 3 shows a system block diagram of a typical configuration of the software of the present invention. The figure shows a first application 301 reading an address 309 of a reference provider 302 in a configuration file 308 (arrow 321). The first application 301 then retrieves two references 306 and 311 from the reference provider 302 (arrows 322, 323). The first application 301 then presents two navigation elements 304 and 310 associated with the references 306 and 311, respectively. In response to a user request, the first application 301 retrieves and displays a first resource 305 referenced by navigation element 304 (arrow 324), the first resource 305 being managed by the reference provider 302. In response to a second user request, the first application 301 retrieves and displays a second resource 307 referenced by navigation element 310 (arrow 325), the second resource 307 being managed by a second application 303.

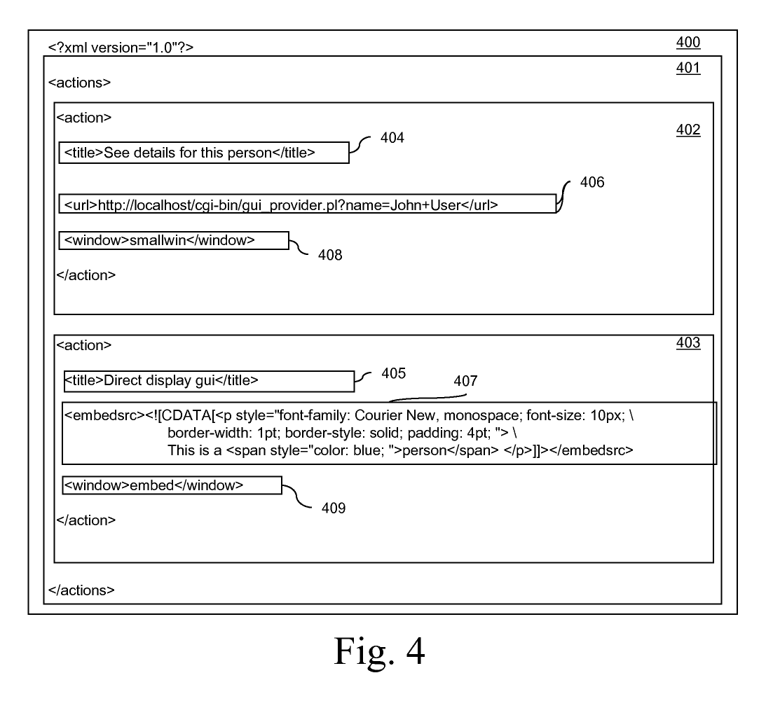

FIG. 4 shows an example of a reference that the first application may retrieve from a reference provider. The example takes the form of an Extensible Markup Language (XML) document 400 as recommended by the World Wide Web Consortium (W3C) and specified at “http://www.w3.org/TR/xml11/”.

Document 400 has a root element 401 containing two “action” elements 402 and 403, each containing a “title” element 404 or 405, respectively. “action” element 402 contains a “url” element 406 containing a valid URL, that URL typically referring to a resource of a Web application. “action” element 403 contains an “embedsrc” element 407 containing the description of structured text to be embedded by the first application.

The contents of “embedsrc” element 407 are typically based on HTML, thus making the structured text described by them suitable for embedding in a web page presented by the first application. For conformance with the XML specification, all HTML markup may be encoded. For example, an “embedsrc” element based on the HTML code “<b>Bold Text</b>” might take one of the forms “<embedsrc>&lt;b&gt;Bold Text&lt/b&gt;</embedsrc>” or “<embedsrc><![CDATA[<b>Bold Text</b>]]></embedsrc>”. The “CDATA” section contained in the latter example is a commonly used mechanism for including non-markup text in XML.

This specific encoding of HTML typically requires the first application to decode the contents of the “embedsrc” element 407 before embedding them. This step may be supported by an XML parser, that is, a program for analyzing the sequence of tokens, or blocks of text, that constitute the XML document 400. As an example, the Java Document Object Model (JDOM) provides the method “getText” to return the textual content directly held under the “embedsrc” element 407, that is, the HTML code.

“action” elements 402 and 403 each contain a “window” element 408 or 409, respectively, indicating a preferred window style to the first application for presenting the referenced information. The content “smallwin” of “window” element 408 may typically cause the first application to display a hyperlink. This hyperlink would start at the source anchor defined by the contents of an associated “title” element and point to a destination anchor defined by the contents of an associated “url” element. The content “smallwin” would also cause the first application to configure the hyperlink for opening in a newly created, relatively small window when activated by a user. By a small window is meant a visual area, usually rectangular in shape, that does not provide a menu, title, or status and that is considerably smaller in size than the screen on which it is displayed. For example, an application using the JavaScript programming language by Netscape Communication Corporation may call the method “window.open” to create such a window.

The content “embed” of “window” element 409 may typically cause the first application to embed the structured text described by the contents of the “embedsrc” element 407. The content “embed” of “window” element 409 would thus cause the first application to consider only the “embedsrc” element 407 and ignore the “title” element 405 contained in action element 403.

Another allowed content of a “window” element may include “normalwin”, also causing the first application to display a hyperlink. As for “smallwin”, this hyperlink would start at the source anchor defined by the contents of the associated “title” element and point to a destination anchor defined by the contents of the associated “url” element. The content “normalwin” would however cause the first application to configure the hyperlink for opening, when activated by a user, in the same window in which the hyperlink is displayed.

Still another allowed content of a “window” element may include “newwin”, again causing the first application to display a hyperlink. As for “normalwin” and “smallwin”, this hyperlink would start at the source anchor defined by the contents of the associated “title” element and point to a destination anchor defined by the contents of the associated “url” element. The content “newwin” would however cause the first application to configure the hyperlink for opening, when activated by a user, in an additional, newly created window.

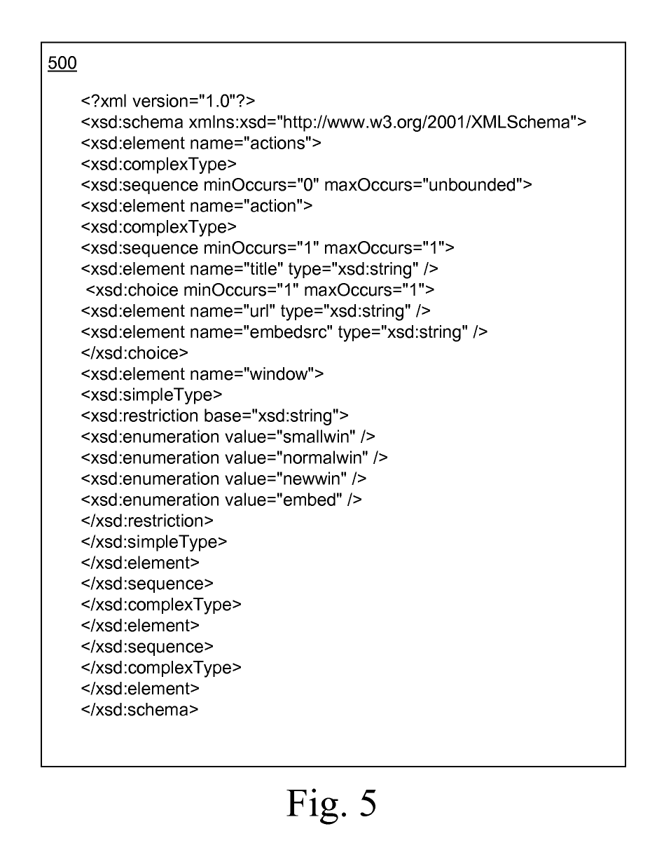

FIG. 5 shows a description for the type of XML document shown in FIG. 4, expressed using the XML Schema language recommended by the W3C. A first application according to the invention would require reference providers to provide references conforming to the XML Schema Definition (XSD) 500.

FIG. 6 shows a system block diagram of a typical computer system used to execute the software of the present invention. The computer system according to FIG. 6 includes subsystems such as central processor 603, system memory 602, I/O controller 601, display adapter 605, removable disk 607 (e.g., CD-ROM drive), fixed disk 609, network interface 610, monitor 606, keyboard 608, and speaker 604. Other computer systems suitable for use with the present invention may include additional or fewer subsystems. For example, another computer system could include more than once processor 603 (i.e., a multi-processor system) or a cache memory.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It is appreciated that although embodiments of the invention have been discussed where action definitions are encoded in XML, this is not to be considered mandatory. It is possible to apply the same method using action definitions in any suitable data format.

It is appreciated that although embodiments of the invention have been discussed where applications are accessed and interconnected via the World Wide Web, this is not to be considered mandatory. It is possible to apply the same method to applications accessed via any suitable system and over any suitable network.

This description explicitly describes some combinations of the various features discussed herein. It is appreciated that various other combinations are evident to a skilled person studying this description.

In the appended claims a method in a computer refers to a method whose steps are performed by a computing system containing a suitable combination of one or more processors, memory means and storage means.

While the foregoing has been with reference to particular embodiments of the invention, it will be appreciated by those skilled in the art that changes in these embodiments may be made without departing from the principles of the invention, the scope of which is defined by the appended claims.

1. A computerized method for providing a navigation element in a first application, comprising:
reading from a configuration entry a first piece of information identifying a reference provider,
reading a second piece of information from said configuration entry or from a memory, said second piece of information being associated with information to be fetched from a second application and comprising a parameter,
retrieving a reference from said reference provider, said reference referring to said information to be fetched from said second application and conforming to a format expected by said second application, and
presenting a navigation element associated with said reference by said first application.

2. Method according to claim 1, further comprising:
reading said parameter from said configuration entry,
replacing said parameter by a value defined in said first application, and
transmitting said value to said reference provider in retrieving said reference.

3. Method according to claim 2, wherein said value is based on a current state of said first application.

4. Method according to claim 1, further comprising receiving from said reference provider or said second application instructions for presenting said information to be fetched from said second application.

5. Method according to claim 4, further comprising:
retrieving, in response to a user request, said information from said second application, and
presenting said information by said first application in accordance with said instructions.

6. Method according to claim 1, further comprising receiving information defining said navigation element from said reference provider.

7. Method according to claim 1, wherein said reference provider is said second application.

8. Method according to claim 1, wherein said first and second applications are Web applications, said navigation element is a hyperlink targeting a uniform resource locator, and said information to be fetched from said second application is a resource accessible via the World Wide Web.

9. Computer program product comprising a computer readable storage medium having a computer readable program, wherein the computer readable program, when executed on a computer, causes the computer to:
read a first piece of information from a configuration entry by a first application, said first piece of information identifying a reference provider,
read a second piece of information from said configuration entry or from a memory means by said first application, said second piece of information being associated with information to be fetched from a second application and comprising a parameter,
retrieve a reference from said reference provider by said first application, said reference referring to information to be fetched from said second application and conforming to a format expected by said second application, and
present a navigation element associated with said reference by said first application.

10. Data processing system for integrating applications, comprising:
storage for storing a configuration entry to be read by a first application, said configuration entry containing a first piece of information for identifying a reference provider and a second piece of information being associated with information to be fetched from a second application and comprising a parameter,
a communication module for communicating with further data processing systems,
a user interface device for presenting information, and
a processing component operatively connected to said storage, communication module and user interface device for retrieving a reference from said reference provider and presenting a navigation element associated with said reference using said user input device, said reference referring to information to be fetched from said second application and conforming to a format expected by said second application.

11. Data processing system for integrating applications, comprising:
at least one computing device including:
a system for reading a first piece of information and a second piece of information, said first piece of information identifying a reference provider from a configuration entry,
a system for reading a second piece of information from said configuration entry or from a memory, said second piece of information being associated with information to be fetched from a second application and comprising a parameter,
a system for retrieving a reference from said reference provider, said reference referring to information to be fetched from said second application and conforming to a format expected by said second application, and
a system for presenting a navigation element based on said reference by a first application.

12. A computer program for execution in a data processing system comprising instructions for carrying out a method according to claim 1 when said computer program is executed on said data processing system.

13. A computer program product embodied on a computer readable storage medium, comprising a computer readable program for causing a computer system to carry out a method according to claim 1 when said computer program is executed on said computer system.
